(19) United States
(12) Patent Application Publication
(10) Pub. No.: US 2008/0285175 A1
(43) Pub. Date: Nov. 20, 2008

(54) DISK DEVICE

(75) Inventors: Takeshi Okutomi, Ome-shi (JP); Hideyuki Miyazaki, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/110,680

(22) Filed: Apr. 28, 2008

(30) Foreign Application Priority Data
May 15, 2007 (JP) 2007-129583

(51) Int. Cl. G11B 5/54

(52) U.S. Cl. 360/254.8

(57) ABSTRACT

According to one embodiment, a magnetic disk device includes a case provided with a base and a top cover. On the base in the case are arranged a motor, a disk-shaped recording medium rotatably supported on the motor, a head, a head actuator which supports the head for movement with respect to the recording medium, and a ramp load mechanism. The ramp load mechanism includes a ramp arranged on the outer peripheral side of the recording medium, and an engaging portion which extends from the head actuator and is configured to run on the ramp when the head is moved to the outer peripheral portion of the recording medium. The ramp has a recess and an elastically deformable bridge portion which straddles the recess and being fixed between the base and the top cover with the bridge portion elastically pressed against the pressing portion of the top cover.

### CROSS-REFERENCE TO RELATED APPLICATIONS

This application is based upon and claims the benefit of priority from Japanese Patent Application No. 2007-129583, filed May 15, 2007, the entire contents of which are incorporated herein by reference.

### BACKGROUND

1. Field

One embodiment of this invention relates to a disk device, and more particularly, to a disk device provided with a ramp load mechanism.

2. Description of the Related Art

In recent years, disk devices, such as magnetic disk devices, optical disk devices, etc., have been widely used as external recording devices of computers or image recording apparatuses.

A disk device, e.g., a magnetic disk device, generally includes a base in the form of an open-topped rectangular box and a top cover that is fastened to the base by screws so as to close a top opening of the base. The base contains therein a magnetic disk, spindle motor, magnetic heads, head actuator, voice coil motor, board unit, etc. The spindle motor supports and rotates the magnetic disk for use as a recording medium. The heads serve to write and read information to and from the disk. The head actuator supports the heads for movement with respect to the disk. The voice coil motor serves to rotate and position the actuator. The board unit includes a head IC and the like.

Further, small portable personal computers are spreading in these years, and magnetic disk devices that are mounted in the personal computers of this type are expected to be improved in reliability against shocks during mobile use or the like.

To cope with this, there is provided a magnetic disk device which includes a ramp load mechanism as a mechanism for holding magnetic heads when the device is non-operating, as disclosed in Jpn. Pat. Appln. KOKAI Publication No. 2005-276368. The ramp load mechanism includes a tab extending from the distal end of a suspension and a ramp located on a base so as to partially overlap the outer periphery of a magnetic disk. If a head actuator is rotated to the outer periphery of the magnetic disk when the magnetic disk device is brought to a non-operating state, the tab of the suspension runs on the ramp, and the magnetic heads are kept apart from the surfaces of the magnetic disk.

In the magnetic disk device described above, the ramp of the ramp load mechanism is positioned and fixed to a case by screws that are driven into the ramp from outside the base and the top cover.

In fixing the ramp in a predetermined position by screwing in the manner described above, however, the ramp must be kept in the predetermined position when it is screwed from both above and below, so that the assembly operation is complicated. Further, the base and the top cover must be provided with through holes for the screws, so that the number of machining operations for the case increases.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary exploded perspective view showing an HDD according to a first embodiment of the invention;

FIG. 2 is an exemplary perspective view showing the internal configuration of the HDD with its top cover off;

FIG. 3 is an exemplary perspective view showing a ramp located in a predetermined position on a base of the HDD;

FIG. 4 is an exemplary plan view showing the ramp located in the predetermined position on the base of the HDD;

FIG. 5 is an exemplary perspective view showing the ramp;

FIG. 6 is an exemplary perspective view of the ramp taken in a direction different from that of FIG. 5;

FIG. 7 is an exemplary perspective view showing the lower end portion side of the ramp;

FIG. 8 is an exemplary perspective view showing the base on which a spindle motor and magnetic disks are mounted;

FIG. 9 is an exemplary perspective view showing a ramp platform of the base;

FIG. 10 is an exemplary perspective view schematically showing an assembly process for the ramp;

FIG. 11 is an exemplary plan view showing an engaging end portion of the ramp in engagement with the ramp platform;

FIG. 12 is an exemplary sectional view showing the ramp fixed between the base and the top cover; and

FIG. 13 is an exemplary perspective view showing a ramp according to a modification of the invention.

### DETAILED DESCRIPTION

Various embodiments according to the invention will be described hereinafter with reference to the accompanying drawings. In general, according to one embodiment of the invention, a magnetic disk device comprises a case provided with a base including a bottom wall and a top cover including a pressing portion and fixed to the base; a motor arranged on the base; a disk-shaped recording medium rotatably supported on the motor; a head which processes information for the recording medium; a head actuator which is arranged on the base and supports the head for movement with respect to the recording medium; and a ramp load mechanism which supports the head actuator in a stop position where the head is kept apart from the recording medium, the ramp load mechanism including a ramp arranged on the outer peripheral side of the recording medium and an engaging portion which extends from the head actuator and is configured to run on the ramp when the head is moved to the outer peripheral portion of the recording medium. The ramp includes a recess and an elastically deformable bridge portion which straddles the recess and being fixed between the base and the top cover with the bridge portion elastically pressed against the pressing portion of the top cover.

An embodiment of this invention in which this invention is applied to a hard disk drive (HDD) as a disk device will now be described in detail with reference to the accompanying drawings.

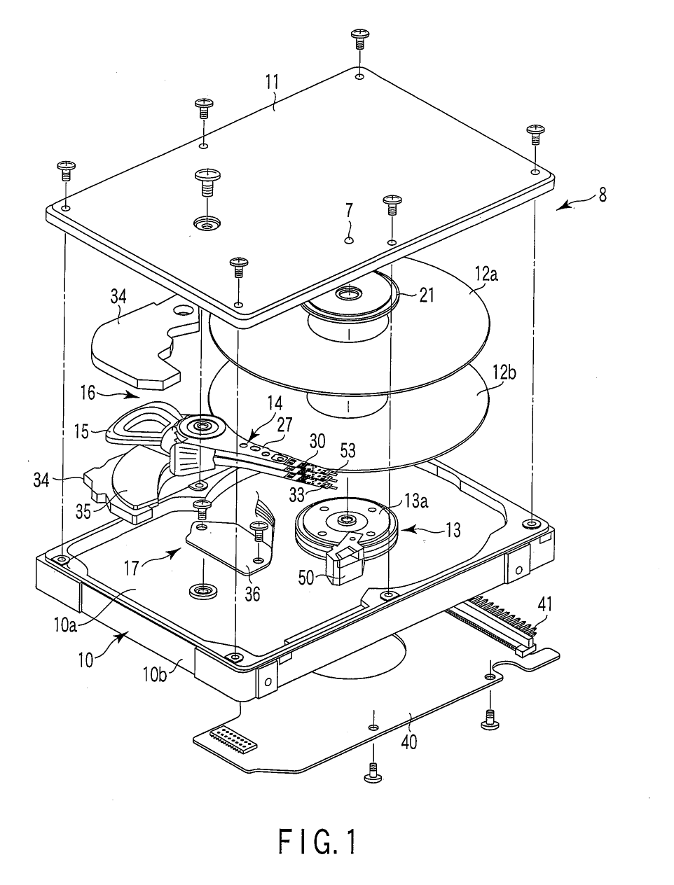

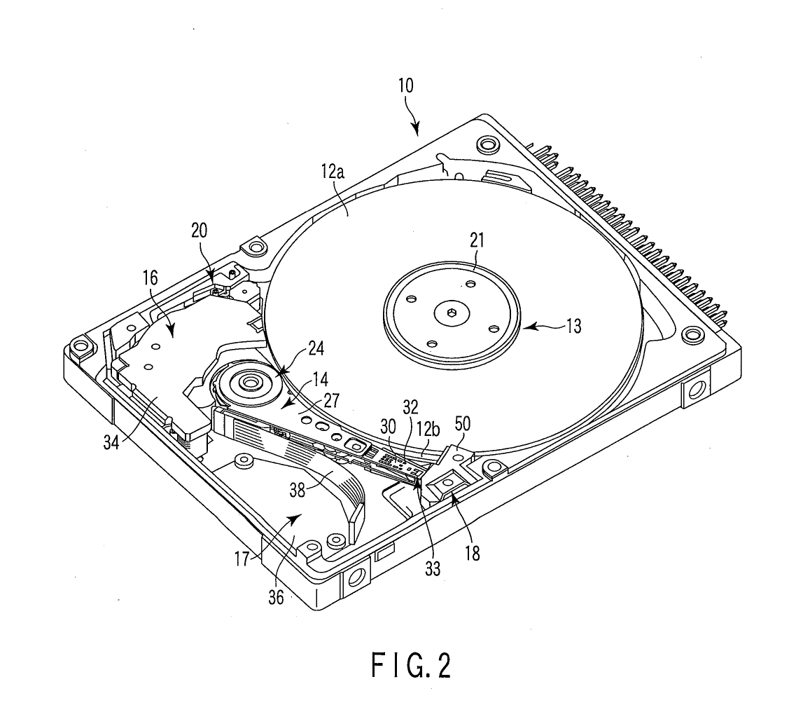

FIG. 1 is an exploded perspective view showing an outline of the HDD, and FIG. 2 is a perspective view showing the internal configuration of the HDD with its top cover off.

As shown in FIGS. 1 and 2, the HDD is provided with a flat, rectangular case 8. The case 8 includes a base 10 in the form of an open-topped rectangular box and a top cover 11 in the form of a rectangular plate, which is fastened to the base by screws so as to close a top opening of the base. The base 10 integrally includes a bottom wall 10a and a sidewall 10b set up along the peripheral edge of the bottom wall. The top cover 11 integrally has a pressing portion that is situated corresponding to a ramp of a ramp load mechanism, which will be described later. The pressing portion includes a positioning boss 7 formed of a part of the top cover 11 that projects toward the base 10.

The base 10 carries thereon, for example, two magnetic disks 12a and 12b, a spindle motor 13, magnetic heads 33, a head actuator 14, and a voice coil motor (VCM) 16. The spindle motor 13 supports and rotates the magnetic disks for use as recording media. The heads 33 serve to record and reproduce information to and from the disks. The head actuator 14 supports the heads for movement with respect to the disks 12a and 12b. The VCM 16 serves to rotate and position the actuator. The base 10 further carries thereon a ramp load mechanism 18, an inertia latch mechanism 20, and a flexible printed circuit board (FPC) unit 17. The ramp load mechanism 18 holds the magnetic heads 33 at distances from the magnetic disks 12a and 12b when the heads are moved to the outermost peripheries of the disks. The inertia latch mechanism 20 serves to hold the head actuator 14 in a retracted position. Circuit components, such as a preamplifier, are mounted on the FPC unit 17. The spindle motor 13, head actuator 14, VCM 16, etc., are disposed on the inner surface of the bottom wall 10a.

The magnetic disks 12a and 12b are formed having a diameter of, for example, 65 mm (21 inches). They are coaxially fitted on a hub 13a of the spindle motor 13 and clamped by a clamp spring 21. Thus, the disks 12a and 12b are fixed on the outer periphery of the hub 13a and supported for rotation integral with the hub. The magnetic disks 12a and 12b are rotated at a predetermined speed by the spindle motor 13.

The head actuator 14 is provided with a bearing assembly 24 set up on the bottom wall 10a of the base 10, four arms 27 supported on the bearing assembly, and magnetic head assemblies 30 supported on the arms, individually. Each magnetic head assembly 30 includes an elongated suspension 32 formed of a leaf spring and a magnetic head 33 fixed to an extended end of the suspension.

When the head actuator 14 is incorporated in the case 8, the magnetic disks 12a and 12b are situated between two of the arms 27. The magnetic heads 33 on the suspensions 32 individually face the upper and lower surfaces of the disks 12a and 12b and hold the disks from both sides. Each magnetic head 33 is subjected to a predetermined head load that is applied toward a magnetic disk surface by the urging force of the suspension 32.

The VCM 16 includes a voice coil 15 attached to the head actuator 14, a pair of yokes 34 fixed on the bottom wall 10a and opposed to the voice coil, and a magnet fixed to one of the yokes.

The FPC unit 17 has a board body 36 fixed on the bottom wall 10a of the base 10. Electronic components, connectors, etc., are mounted on the board body. The FPC unit 17 includes a belt-shaped main flexible printed circuit board 38, which electrically connects the board body 36 and the head actuator 14. Each magnetic head 33 that is supported by the actuator 14 is electrically connected to the FPC unit 17 through the printed circuit board 38 and a relay FPC (not shown) on each arm 27. A breathing filter, a circulation filter, etc., are arranged around the base 10 in the vicinity of the magnetic disks 12a and 12b.

A printed circuit board 40 for controlling the operations of the spindle motor 13, VCM 16, and magnetic heads 33 through the FPC unit 17 is screwed to the outer surface of the bottom wall 10a of the base 10 and faces the bottom wall 10a. A number of electronic components including connectors 41 are mounted on this printed circuit board 40. The printed circuit board 40 is located so that its surface on which the electronic components are mounted faces the outer surface of the bottom wall 10a.

The ramp load mechanism 18 includes a ramp 50 disposed on the bottom wall 10a of the base 10 on the outer peripheral side of the magnetic disks 12a and 12b and tabs 53 as engaging portions that extend individually from the respective distal ends of the head suspensions 32. If the magnetic heads 33 individually leave the outer peripheries of the disks 12a and 12b and move to predetermined stop positions when the HDD is non-operating, each tab 53 runs on the ramp 50. Thereupon, the magnetic heads 33 are kept off the disks 12a and 12b.

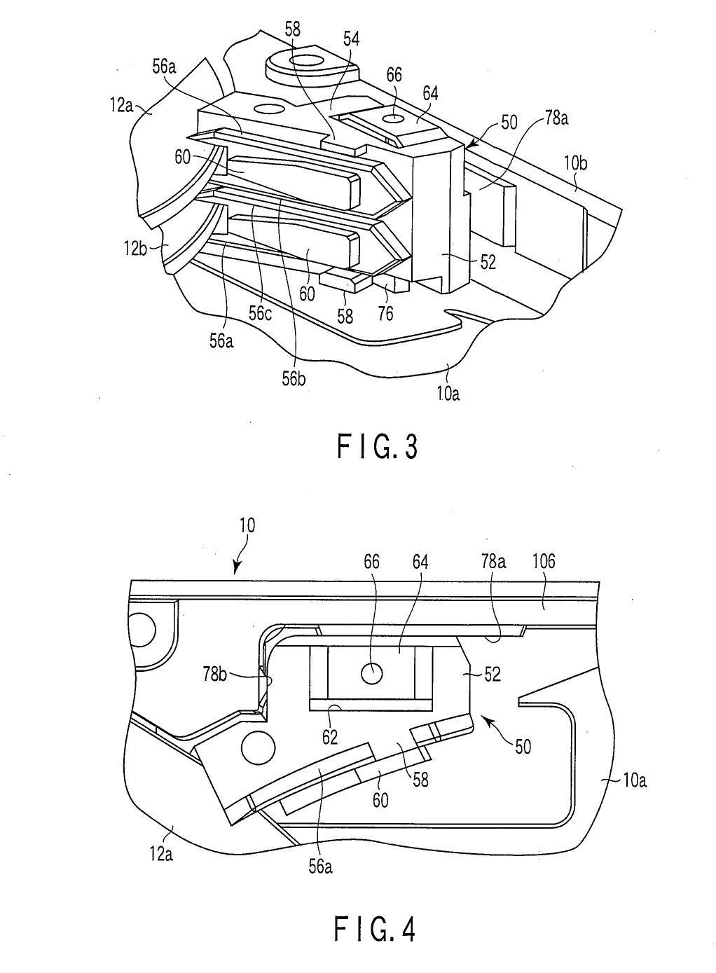

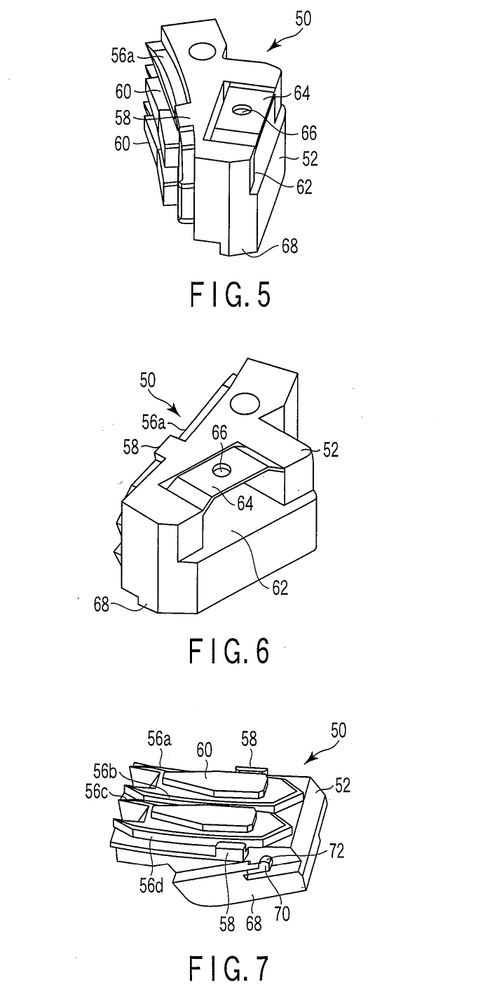

FIGS. 3 and 4 show the ramp that is located in a predetermined position on the bottom wall of the base 10, and FIGS. 5, 6 and 7 show external views of the ramp taken in different directions. As shown in FIGS. 3 to 7, the ramp 50 is provided with a block-shaped body 52. Four guide surfaces 56a, 56b, 56c and 56d are formed on one side portion of the body 52. They guide the tabs 53 on the four suspensions 32, individually. The guide surfaces 56a to 56d are arranged at predetermined intervals in the axial direction of the magnetic disks 12a and 12b and aligned in height with their corresponding suspensions 32. Further, the guide surfaces 56a to 56d extend close to the respective outer peripheral edges of the disks 12a and 12b, substantially in the radial direction of the disks, and are located individually on movement paths of the tabs 53 on the suspensions 32. The two guide surfaces 56a and 56c corresponding to the first and second suspensions 32, as viewed in the descending order, respectively, are formed with their faces upward, while the two guide surfaces 56b and 56d corresponding to the second and fourth suspensions 32, respectively, are formed with their faces downward.

Each of the guide surfaces 56a to 56d includes a slope, which declines toward the magnetic disk 12a or 12b so that each magnetic head 33 can be loaded onto or unloaded from the disk, and a flat portion that extends adjacent to the slope and parallel to a surface of the magnetic disk.

Further, tab retainers 58 and gimbal retainers 60 are formed integrally on one side portion of the body 52. The tab retainers 58 are opposed to the guide surfaces 56a to 56d with predetermined gaps between them. The gimbal retainers 60 protrude from the body 52 so as to be situated between the adjacent tab retainers.

A substantially rectangular recess 62 is formed in the body 52. The recess 62 opens in the top surface of the body 52 and the other side portion of the body opposite from the guide surfaces 56a to 56d. The ramp 50 includes an elastically deformable bridge portion 64 that straddles the recess 62. The bridge portion 64 is in the form of a plate with a predetermined width, and its opposite end portions are fixed to the body 52. It is disposed in a position slightly above the top surface of the body 52, that is, a little higher on the side of the top cover 11. The bridge portion 64 faces the recess 62 and the cover 11 and extends substantially parallel to the bottom wall 10a and the cover 11. An engagement hole 66 that is configured to engage with the positioning boss 7 of the top cover 11 is formed in the central part of the bridge portion 64.

The bridge portion 64 is elastically deformable in a direction perpendicular to the bottom wall 10a of the base 10 around its own opposite end portions that are connected to the body 52. Since the bridge portion 64 has the predetermined width, moreover, it is restrained from being deformed or twisted in a plane direction parallel to the bottom wall 10a. The bridge portion 64 is molded integrally with the body 52 from the same material, e.g., a synthetic resin.

As shown in FIG. 7, the lower end portion of the body 52 of the ramp 50 constitutes an engaging end portion 68 that abuts and engages with the bottom wall 10a of the base 10. The engaging end portion 68 includes an elastically deformable engaging pawl 70, and a positioning projection 72 is formed on an extended end of the pawl 70.

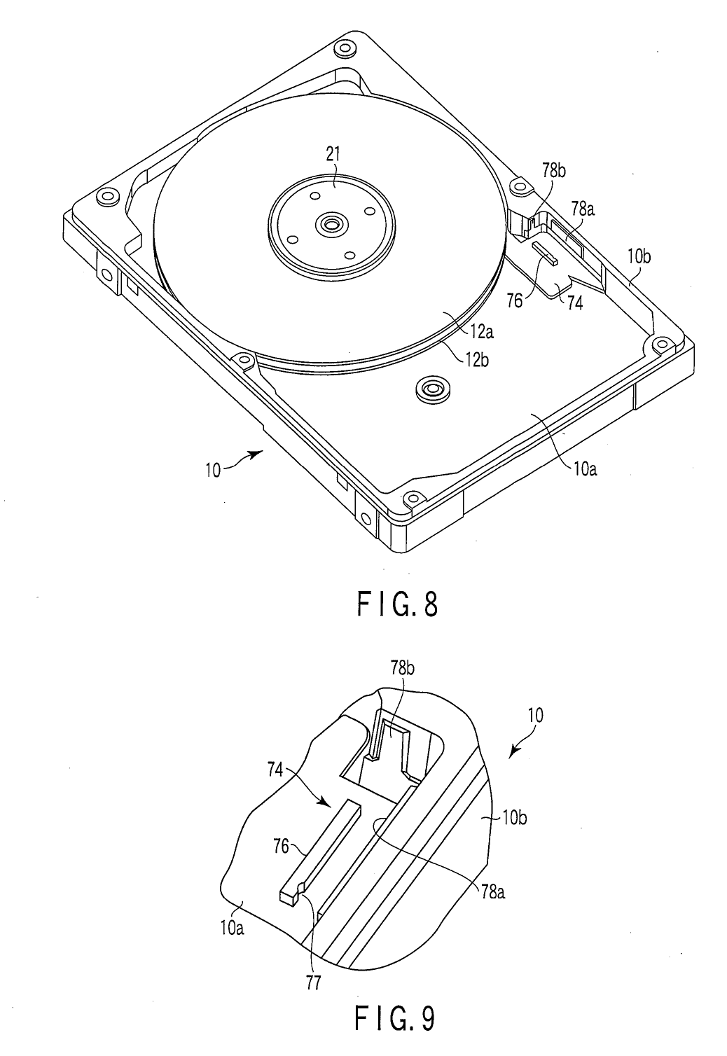

As shown in FIGS. 8, 9, 10 and 11, a flat ramp platform 74 is formed on the bottom wall 10a of the base 10. The ramp platform 74 is located adjacent to the sidewall 10b of the base 10 outside the magnetic disks 12a and 12b. An elongated straight guide rail 76 protrudes from the ramp platform 74. The guide rail 76 extends across the disks 12a and 12b, that is, parallel to the sidewall 10b in this case. A positioning recess 77 as an engaging portion is formed at one end portion of the guide rail 76. Further, the sidewall 10b is formed with abutting portions 78a and 78b, which are situated adjacent to the ramp platform 74 and abut the ramp 50. The one abutting portion 78a faces the guide rail 76 in substantially parallel relation, while the other abutting portion 78b extends at right angles to the guide rail.

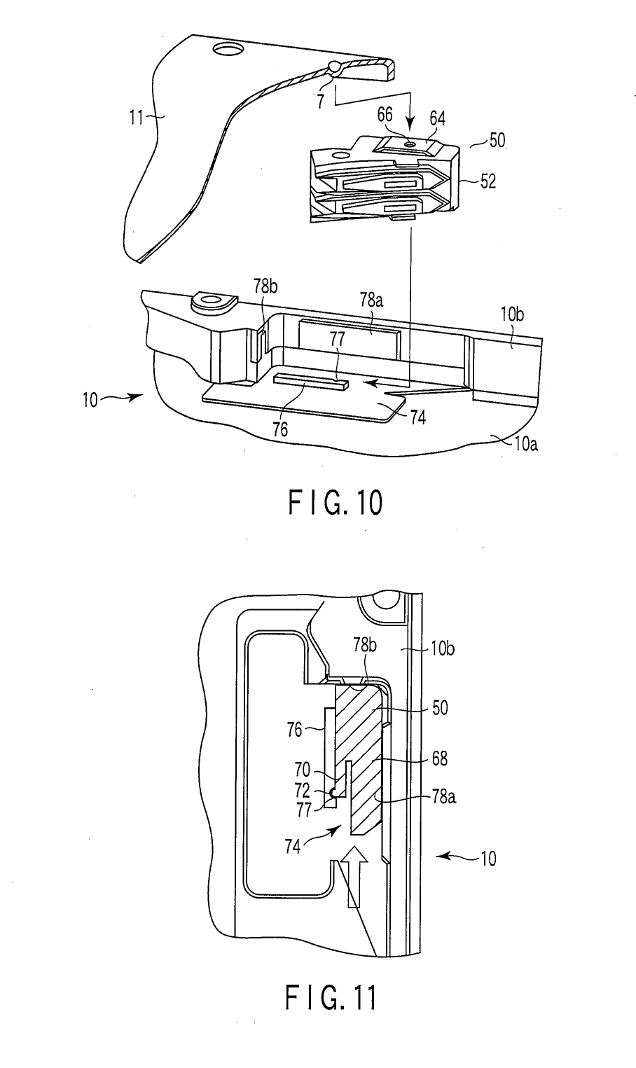

In assembling the HDD, the ramp 50 is attached to the case 8 in the following processes. First, the spindle motor 13 and the two magnetic disks 12a and 12b are mounted on the base 10, as shown in FIG. 8. Then, the ramp 50 is placed onto the ramp platform 74 of the base 10 from above so that its engaging end portion 68 abuts on the bottom wall 10a and is located between the guide rail 76 and the abutting portion 78a, as shown in FIGS. 10 and 11. Then, the ramp 50 is slid toward the disks 12a and 12b with the guide rail 76 used as a guide and moved to a predetermined position where it abuts the abutting portion 78b. When the ramp 50 is moved to the predetermined position after the engaging pawl 70 on the engaging end portion 68 is elastically deformed, the positioning projection 72 engages with the positioning recess 77 of the guide rail 76.

Thus, the ramp 50 is positioned in a manner such that its engaging end portion 68 is in surface contact with the ramp platform 74 and sandwiched between the guide rail 76 and the abutting portion 78a. At the same time, the positioning projection 72 engages with the positioning recess 77 of the guide rail 76, whereupon the ramp 50 is restrained from moving in its sliding direction and is held in the predetermined position where it abuts the abutting portion 78b. In the predetermined position, moreover, the distal end portion of the ramp 50 is situated overlapping the respective peripheral edge portions of the magnetic disks 12a and 12b.

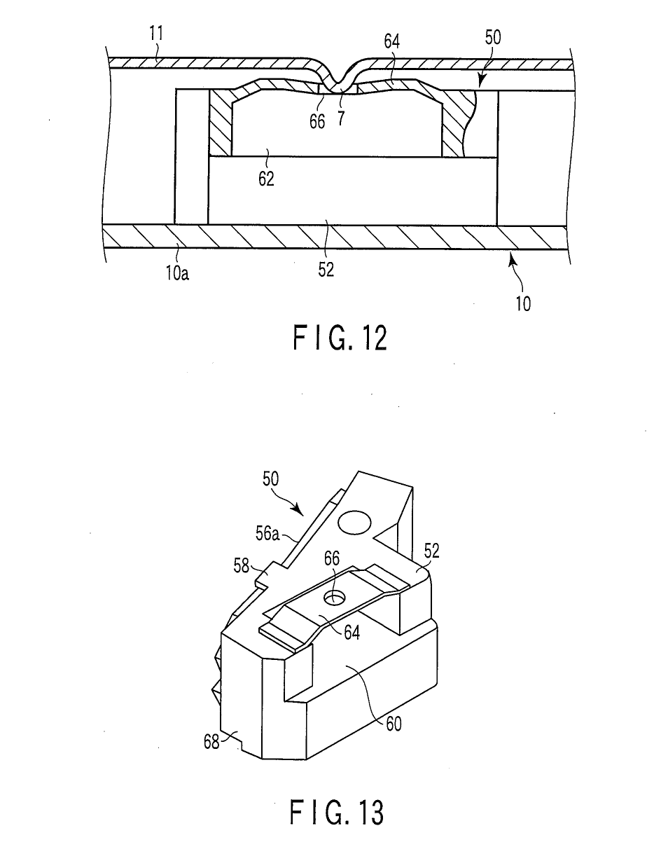

After the ramp 50 is mounted on the ramp platform 74, other components, such as the head actuator 14, VCM 16, etc., are mounted in place. Subsequently, the top cover 11 is screwed to the base 10, whereupon the top opening of the base is closed, as shown in FIGS. 10 and 12. As this is done, the positioning boss 7 on the top cover 11 engages with the engagement hole 66 of the bridge portion 64 of the ramp 50, thereby pressing the bridge portion 64 toward the base 10. The bridge portion 64 is elastically deformed toward the base 10, thereby pressing and fixing the entire ramp 50 on the base 10. As the positioning boss 7 engages with the engagement hole 66, moreover, the bridge portion 64 is positioned with respect to the plane direction of the bottom wall 10a. Thus, the ramp 50 is sandwiched between the base 10 and the top cover 11 when it is located and fixed in the predetermined position. Since the ramp 50 is pressed by the opposite end portions of the bridge portion 64, moreover, it is prevented from tilting or shifting its position.

According to the HDD constructed in this manner, the ramp 50 can be securely held between the base 10 and the top cover 11 without the use of screws by utilizing the top cover and the elasticity of the bridge portion 64. Thus, the ramp can be more easily fixed in the predetermined position than in the case where it is screwed, so that the assemblability can be improved. Further, the base and the top cover need not be formed with any through holes or the like for screwing, so that the number of screws and machining operations can be reduced to lower the manufacturing cost. Furthermore, the airtightness of the case can be improved.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

In the HDD, for example, the number of magnetic disk is not limited to two but may be varied as required. Further, the bridge portion of the ramp may be formed of a material different from that of the ramp body, instead of being molded integrally with the ramp body. According to an embodiment shown in FIG. 13, a bridge portion 64 is formed of a resin or metal that is different from the material of a body 52, and its opposite end portions are fixed to the body 52 by adhesive bonding or some other method. The same function and effect as those of the foregoing embodiment can also be obtained with use of the ramp constructed in this manner.

What is claimed is:

1. A magnetic disk device comprising:
a case provided with a base including a bottom wall and a top cover including a pressing portion and fixed to the base;
a motor arranged on the base;
a disk-shaped recording medium rotatably supported on the motor;
a head which processes information for the recording medium;
a head actuator which is arranged on the base and supports the head for movement with respect to the recording medium; and
a ramp load mechanism which supports the head actuator in a stop position where the head is kept apart from the recording medium,
the ramp load mechanism including a ramp arranged on the outer peripheral side of the recording medium and an engaging portion which extends from the head actuator and is configured to run on the ramp when the head is moved to the outer peripheral portion of the recording medium,
the ramp including a recess and an elastically deformable bridge portion which straddles the recess and being fixed between the base and the top cover with the bridge portion elastically pressed against the pressing portion of the top cover.

2. The magnetic disk device according to claim 1, wherein the bridge portion extends substantially parallel to the bottom wall of the base and is elastically deformable in a direction perpendicular to the bottom wall.

3. The magnetic disk device according to claim 2, wherein the ramp has an engagement hole formed in the bridge portion, and the pressing portion of the top cover includes a positioning boss which engages with the engagement hole and restrains the ramp from moving in a plane direction of the bottom wall.

4. The magnetic disk device according to claim 2, wherein the ramp is integrally molded including the bridge portion.

5. The magnetic disk device according to claim 2, wherein the ramp includes a body formed with the recess, and the bridge portion is formed of a material different from that of the body and fixed to the body.

6. The magnetic disk device according to claim 1, wherein the base includes a sidewall set up along a peripheral edge of the bottom wall, a flat ramp platform formed on the bottom wall, a guide rail which is formed on the ramp platform to extend in a direction across the recording medium and includes an engaging portion, and an abutting portion disposed on the sidewall and opposed to the guide rail, and the ramp is placed on the ramp platform and provided with an engaging end portion held between the guide rail and the abutting portion and positioning projection which elastically engages with the engaging portion of the guide rail and restrains the ramp from moving in an extending direction of the guide rail.

7. The magnetic disk device according to claim 1, wherein the ramp has an engagement hole formed in the bridge portion, and the pressing portion of the top cover includes a positioning boss which engages with the engagement hole and restrains the ramp from moving in a plane direction of the bottom wall.
